(19) United States
(12) Patent Application Publication
(10) Pub. No.: US 2012/0185330 A1
(43) Pub. Date: Jul. 19, 2012

(54) Discovery and Publishing Among Multiple Sellers and Multiple Buyers

(75) Inventors: Leonard Kleinrock, Los Angeles, CA (US); Yu Cao, Monterey Park, CA (US); Louise Falevsky, Rancho Palos Verdes, CA (US)

(73) Assignee: PLATFORMATION, INC., Monterey Park, CA (US)

(21) Appl. No.: 13/350,201

(22) Filed: Jan. 13, 2012

Related U.S. Application Data
(60) Provisional application No. 61/433,071, filed on Jan. 14, 2011.

(51) Int. Cl. G06Q 30/02

(52) U.S. Cl. 705/14.49; 705/27.1

(57) ABSTRACT

A framework for discovery and publishing among multiple sellers and multiple buyers leads to contemplated embodiments in planning online and shopping at local stores. Through the contemplated embodiments, sellers publish incentives and information to a platform, which matches, in a timely and personalized manner, buyers' purchase intentions that are often manifested as submitted and saved shopping lists or receipts.

This application claims the benefit of priority to U.S. provisional application having Ser. No. 61/433,071 filed Jan. 14, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is advertising technologies.

### BACKGROUND

“There are known knowns; there are things we know that we know. There are known unknowns; that is to say, there are things that we now know we don't know. But there are also unknown unknowns; there are things we do not know we don't know”.—United States Secretary of Defense Donald Rumsfeld.

The quote above aptly describes a state of what is called “discovery”. Discovery concerns itself with finding out the “unknowns”, whether they happen to be “known unknowns” or “unknown unknowns”. The object of discovery, however, is not described in the above quote, and it is proposed that the object of discovery is placed in a space where discovery takes place, and that such an object is placed in the said space by a process defined as “publishing”. This discovery also takes place within a time-bounded interval within the discovery space. The bounding of discovery in time and space is called “time-space”.

Consider a shopper buying groceries who naturally wants to be able to buy the things they want at places that save them money and preferably save time, defined as “shopping economy”, on the shopping trips. To elaborate, the shopper first has to answer the question of what to buy, in order to fulfill her purpose; after that the shopper wants to achieve economy within consideration of the following: (a) Where to buy considering tangible factors (such as a store's product selections) and intangible factors (such as a store's cleanliness); (b) What to buy considering tangible factors (such as a product's pricing) and intangible factors (such as the “feel good” factor of buying organic foods); (c) Price optimization (to pay as little as possible, one of many possible forms of tangible factor optimization); and (d) Maximizing the experience of desired intangibles.

The same economy can be achieved in practically any human activity; including but not limited to shopping (both the research and purchase behaviors) for goods and services.

A shopper is more willing to be guided when that shopper is not sure what to buy or what services and activities are available in their area. A shopper can read reviews on Yelp.com (or CitySearch, among other sites) or can Google shopping questions, which will direct that shopper to sites devoted mainly to product and store reviews (DigitalCameraInfo.com, e.g.).

Once the shopper knows what he or she wants to buy or do, the question of “where to shop” needs to be answered. By this time, the shopper is in a “sourcing” mode where the shopping economy objective is to expend the least amount of time and/or money in order to get what they need. The goal of shopping economy is shared by most everyone: no one likes to find out after the fact that they have paid more than was necessary. Or even worse, having done so with additional inconvenience.

To achieve shopping economy, however, the shopper faces information intractability and the corresponding obstacles.

Intractability A: the multiplicity and complexity of comparables information. As long as a shopper has flexibility, in order to achieve shopping economy he or she needs to choose among “comparables”.

First, choose from among “comparables” in product composition. A shopper can choose, in a “bill of materials” manner, either “off the shelf” products (think of potato salad at a deli counter) or “do-it-yourself solutions” (e.g., making the said potato salad from raw potatoes and other ingredients).

Second, choose from among “comparables” in products. A shopper can buy different items (e.g., apples or oranges could both be good choices for the family this week) that are both acceptable to the family.

Third, choose from among “comparables” in suppliers or brands. Typically a shopper has multiple suppliers (national, small independent, and store brands) from which to choose.

The multiplicity of comparables is exponentially amplified when a shopper needs to get a variety of items during one shopping trip.

Thusly Obstacle A: inaccessibility to sufficient comparative information. A shopper typically does not have access to all the comparative information needed in order to achieve shopping economy.

Intractability B: The ephemeral nature of information. A shopper's quest for shopping economy, already sub-optimal, is further exacerbated in that the available information space is an ephemeral one, where products and services come and go and prices (along with other attributes) change over time.

Thusly Obstacle B: inaccessibility to real-time information, as well the computational power needed to evaluate the available information. A shopper typically does not have access to all the real-time information needed in order to achieve shopping economy. Even when a shopper has all the information required to make proper shopping economy choices, the computational power required to quickly figure out a good (not to mention an optimal) economic choice is not available.

Intractability C: the cooperation/competition among similar shoppers. The availability of a product or service, as well as the pricing, waiting time, and other quality indices of that product or service might change because of the possible cooperation or competition among similar shoppers.

Thusly Obstacle C: inaccessibility to a mechanism that informs the shopper of the status of their fellow shoppers' activities. Shoppers are better able to make a decision on whether to shop for a particular item at all or whether to take advantage of a shorter waiting time, if they know what fellow shoppers are doing. The shopping behavior status of interest with regards to their fellow shoppers includes not only their action of product purchase, but also their intention to purchase a particular product or service.

Intractability D: that incentive offers and decisions for purchase often take place in asynchronous or non-aligned time-space. Consider a shopper wanting to buy an automobile. Her research can span over a period of several months or other extensive time frames, including multiple “sessions” on the phone with friends, on search engines, on blogs, on car manufacturers' web sites, on blue book sites, or a mobile device equivalent to the above sources of information. While she's engaged in these sessions, her decisions for purchase is taking shape over the time of several months or other time frame, but typically incentive offers are not available in the same time-space of her sessions. Consider also a shopper at multiple points between the home (or office) and the store's checkout register. At each point in this time-space, the shopper might receive advertised incentives and/or the shopper might be making shopping decisions. However, such incentives (such as manufacturers' coupons, weekly special pricing, coupons printed on the back of receipts) typically are designed days or weeks before the shopper is exposed to the incentive information (and additionally the information is broadcast, not personalized for the said shopper), thus being days or weeks after the issue of the incentive and before the shopper might be exposed to the incentive and make shopping decisions.

Thusly Obstacle D: the seller's inaccessibility to a mechanism that informs timely a shopper of incentives only “short moments” before the shopper is looking through products that he or she intends to purchase. Such a mechanism is able to bring into one “time-space” the publishing of incentives (as well as other information that sellers want to publish) and information discovery that will inform the making of shopping decisions (as well as the manifestation of purchase intentions).

Therefore, there are the following needs that are not satisfactorily served by the state of the art:

(i) There is a need for establishing a framework for assessing the discovery and publishing process.

(ii) There is a need for refining the current cognitive tools of “labeling”.

A tool human beings use to process information is what we call “labeling”, namely grouping similar proper names, and for each group, assigning a description, which is a label for the group. Once labeled, humans typically remember the labels and groups of labels in an activity we call “caching”. Collectively, the term “mindshare” encompasses the concept of aggregated groups of labels adopted by a large segment of consumers.

We list some of the labels that are common in today's shopping.

The label of “everyday low price” that Walmart carries, for example, communicates to the shopper their general description of prices; namely if you shopped at Walmart for a variety of goods over a long period of time, the total price of those goods would be low when compared with other stores prices. However, such labeling does not address the individual comparative pricing of a product sold at Walmart.

The label “gift store” communicates to the shopper the likelihood that many small gifts, most of them difficult to describe by product name and specifications, are sold at a store labeled as a “gift store”.

The label “shopping center” may communicate to the shopper the idea that they can get “pretty much everything” in such a shopping place.

The label of “middle class shopper” conveys a much different shopper profile than that of an “upper middle class shopper”. The upper middle class shopper is more likely to have exquisite taste in wine and be willing to spend more money on wine from a well-regarded vintner and at a higher cost whereas a middle class shopper is probably more likely to take cost into account when buying wine and not be too concerned about the vintage.

(iii) There is a need for a common time-space where stores' information meets with shoppers needs where intent of a publisher can be meshed with an intent of a shopper.

The state of the art for communicating most shopper information is still carried out by traditional advertising vehicles (e.g. weekly special ads, TV ads, coupons, coupons-on-back-of-receipts, etc.) that addresses shoppers' needs through seller's broadcast offers; a disjoint time-space information experience often leaving the shopper an imprecise impression of what is offered by the sellers' and most always contextually removed from the time-space experience where the shopper performs shopping planning or executes the shopping task.

To reside in the same time-space for shopping decision-making means that the feedback loop between a user submitting (or implying) a need and the presentation to the user of advertising matching that need is “speedy” as in real-time at the human-machine interface. With the speedy feedback, the shopper becomes more engaged in the real-time selection activity and the advertiser can respond by making more engaging offers available in the real-time space. The more advertising information usage occurs in real-time, the more closely coupled the time-space convergence becomes for both parties. In other words, the information-choice feedback system is responsive at the human-machine interface level and it is more useful than the feedback loop that exists today, both for shoppers as well as for publishers; therefore more shoppers and more publishers using the system will make it increasingly useful. Further, since a shopping decision-making process might take multiple sessions over a long period of time (for example, days, weeks, months, years, etc.), the shoppers' activities in these sessions must be saved and retrievable. The retrieved activities can be used in analysis anew.

The above phenomenon is analogous to HTTP in the early 1990s. In the late 1980s and early 1990s, both Usenet newsgroups and Gopher were available to provide information on the Internet. Therefore the time-space of publishing and consumption of some information had been tied together online already, but it still required considerable work and technical training by the users and responsiveness from the publishers was clearly lacking. With the advent of HTTP and web browsers, a user now did not have to do much other than clicking links and the response time from information need to response was short enough for satisfactory viewing. Publishers started to take a more active role in accessing what information was being consumed and responded in a more timely manner. As a result, the publishing and consumption of information exploded in the years after web browsers were available to users without users requiring any training in using computer software.

(iv) There is a need for optimizing comparison of tangible motivation factors.

Once a shopper knows what to purchase, the decision on where to shop many times hinges upon tangible factors, such as the prices, the brands, and the size of packaging, of products. Such comparison needs to be done at the level of individual products, but also hopefully at the level of the entire shopping list of items—Many times there can easily be scores of items totaling hundreds of dollars. The opportunity for optimization is ample—for a simple example, if a shopper can buy ⅓ of the items on the shopping list in store A and the rest in store B, the savings realized over buying everything in either store could be substantial enough to make the extra stop worthwhile.

(v) There is a need for communicating and comparing intangible motivation factors.

Many times a shopper chooses a store based on “intangible” factors, such as the store being convenient to travel to, the friendliness of the store staff, or the cleanliness of the interior of the store. Such factors are difficult to communicate to a shopper who has never visited that particular store—Both the seller, and fellow shoppers, can fill the communication gap on these intangibles.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

### SUMMARY OF THE INVENTION

The inventive subject matter provides apparatus, systems and methods in which a buyer can discover opportunities based on published promotions from sellers. One aspect of the inventive subject matter includes a method of publishing by a seller and discovering by a buyer. Preferred methods include providing access to a discovery engine capable of mapping a buyer's intentions to a seller's intentions associated with one or more published promotions (e.g., incentives, advertisements, etc.). Buyer and seller interfaces to the discovery engine can be provided to the respective parties through which they can interact with one or more services offered by the discovery engine. Preferred methods also include providing access to a concept database storing concept object representative of intentions that buyers, sellers, or other entities might have when interacting with the system. A concept object can be considered a manageable object comprising one or more attributes describing the nature of the object, possibly where the attributes conform to a common normalized namespace.

Sellers can access the discovery engine through the seller interface, through which the seller can define one or more attributes office the seller intention concept behind a promotion. In some embodiments, the seller can be presented with possible attributes that conform to the namespace. The seller can also utilize the seller interface to submit payments in exchange for accessing or otherwise utilizing the system.

Buyers can also access the discovery engine through a buyer interface. Buyers can submit one of more queries to a search engine. In some embodiments, the buyer interface comprises a web interface to a public search engine (e.g., Google®, Yahoo!®, Bing®, etc.), while it is also contemplated the buyer interface can also comprises a interface to a proprietary database or other engine capable of generating a result set considered responsive to the query.

More preferred methods associated with the inventive subject matter include the discovery engine taking analyzing the query or result set with respect to the seller's intention. The discovery engine can identify a buyer's intention concept based on the query or attributes associated with the result set by consulting the concept database to find a concept having attributes that satisfy selection criteria. The discovery engine can then establish an intention migration path linking the buyer's intention to the seller's intention through linking concepts. Each concept beginning with the buyer's intention concept comprises attributes the more closely align with the buyer's intentions. As the buyer continues to interact with the discovery engine, the discovery engine can modify results sets to subtly influence the buyer's searching or shopping behavior toward the seller's intentions, thus reducing barriers of a buyer adopting the seller's promotions.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 presents the discovery of “Unknowns” via push and pull, starting with “Knowns”.

FIG. 2 is a schematic of a non-optimal shopping platform.

FIG. 3 is a schematic of a more optimal shopping platform capable of generating discovery events.

FIG. 4 is a schematic of a possible listing of tangible motivation factors why a shopper shops for grocery items at a particular store.

FIG. 5 is a schematic of a possible listing of intangible motivation factors why a shopper shops for grocery items at a particular store.

FIG. 6 is a schematic of a possible listing of additional tangible motivation factors why a shopper shops for grocery items at a particular store.

FIG. 7 is a schematic of a possible listing of tangible motivation factors why a shopper shops for a specific perishable item (e.g. chicken) at a particular store.

FIG. 8 is a schematic of a possible listing tangible motivation factors why a shopper shops for a specific non-perishable item (e.g. cereals) at a particular store.

FIG. 9 is a schematic of a possible user interface through which a shopper is able to choose products.

FIG. 10 is a schematic of a possible user interface through the contemplated platforms can present optimized lists as a result of discover events.

FIG. 11 is a schematic of a possible discovery engine environment where buyer's can discover possible opportunities published by a seller.

FIG. 12 illustrates bridging between a buyer's intention to a seller's intention.

FIG. 13 illustrates an example of an intention migration path through which a buyer's intention can be mapped to a seller's intention.

FIG. 14 is a schematic of a method for allowing a buyer to discover possible opportunities published by a seller.

### DETAILED DESCRIPTION

It should be noted that while the following description is drawn to a computer/server based discovery engines, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including a discovery engine infrastructure capable of generating a signal that can be sent to a buyer's interface and that configures the buyer's interface to present modified result sets that migrate away from a search intention toward a desired intention.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

(A) A Preparation: a Framework for Discovery and Publishing

For product discovery and publishing among multiple sellers and multiple buyers, a mall is a good analogy. A buyer is confident that the mall has “pretty much everything” that they need and the publisher (a store) is confident that by placing itself in the mall, publishing economy is achieved. The smallest general store on the western frontier 100 years ago serves the same function. For tangible motivation factors, an “everyday low price” store such as Walmart, achieves shopping economy in discovery such that a shopper can be reasonably correct that they will save money without expending a lot of time to discover that the price at Walmart is inexpensive.

It is through “labeling” and “caching” that we currently determine what actions to take for shopping economy. Still a sub-optimal solution is achieved (due to the high cost of discovery).

However, with a time-space platform where publishing and discovery are conducted in a tightly coupled manner, a solution better than the above is achievable.

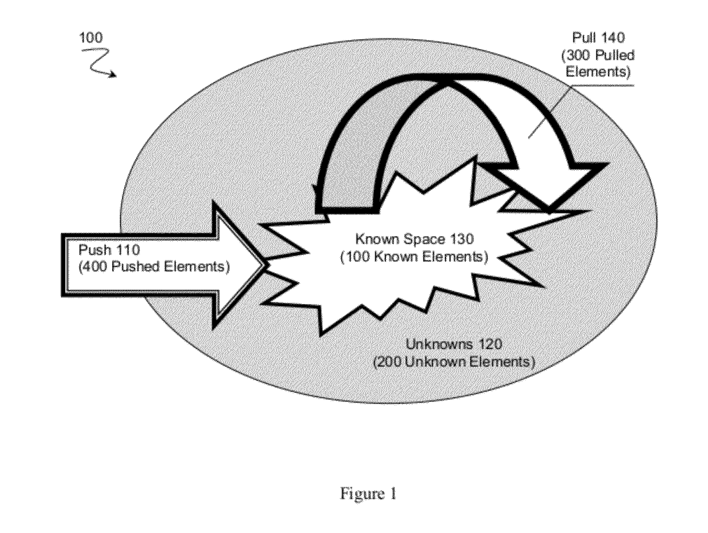

As an example, consider push-pull environment 100 depicted in FIG. 1 where a person can discover unknown elements through a push from a publisher or a pull from the person. Known space 130 contains 100 known elements representing what a person knows. Unknown space 120 contain 200 unknown elements and represents what the person does not know, regardless of whether the unknown element is a “known Unknown” or an “unknown Unknown”. Through information push 110, an additional 400 pushed elements are pushed into the known space 100. Out of the 400 pushed elements, 100 of them match unknown elements creating a scenario where the person to reduce the number of unknown elements to 100 unknown elements through a discovery process. In a complementary action, the person can discover at least some of the pushed elements by attempting to pull information from unknown space 120. Through the pull process, the person can discover that 100 matching pushed elements and convert them to an additional 100 known elements.

At the core of this framework is a platform that helps discover the “known Unknowns” and “unknown Unknowns”. The main method for discovery of Unknowns is that of illuminating a space that's “dark” to the shopper which employs, among other things, “Push” and “Pull”. Implementation of Pull and Push includes but is not limited to: “association”, “similarity”, or “relevancy”, applied to multiple dimensions of products, personalization, locality, and temporality. A guiding objective function, namely to measure optimality, is economy of discovery. An example is evidenced in cooking where the cook's food preparation effort is shared by whoever eats the cooked food and as a result economizing everyone else's time in preparing food and digesting. At the core, the platform uses an optimization mechanism to achieve shopping economy without the shopper or the publisher relying solely on “labeling” or “caching”.

By presenting “Unknowns” to the shopper directly via Push, the shopper is directly given the appropriate “labeling” in a meaningful context and those labels are easily added to the shopper's “caching” process. Meanwhile, the Pull by the shopper converts the Unknown into a Known thereby optimizing the discovery process and enhancing shopping economy.

It is converting “unknowns” to “knowns”, thus expanding the shopper's space of “knowns”, as well as facilitating or enabling actions associated with the “knowns”, that are at the core of the platform's usefulness.

On the platform, multiple publishers exist, and they exhibit the network effect of multiple publishers. It is observed that it is a common occurrence that more than one sellers compete for shoppers' patronage. With multiple sellers, each acting as a publisher, a buyer faces multiple publishers, each of which tries to impact the labeling and caching of the buyer. The network effect of multiple publishers enhances the effectiveness of publishing to the buyer, because the more publishers on the platform, the more information accessible to the buyer at one time-space, and the easier shopping economy can be computed or discerned.

On the platform, multiple buyers exist, and they exhibit the network effect of multiple buyers. The more buyers there are, the better the chance that group-buying can occur. The more buyers, the better communication can be achieved among buyers on intangible factors such as store cleanness.

The platform exhibits the network effect of connecting multiple publishers and multiple buyers. The more publishers and the more buyers there are connected through the platform, the more effective matching can be achieved between a publisher's information and the requests manifested by a buyer.

(A.1) Intangible Attributes

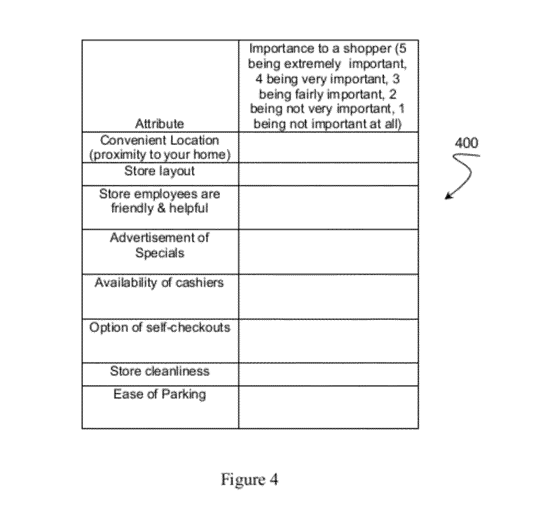

Referring to FIG. 4, table 400 represents some intangible motivation factors why a shopper shops for grocery items at a particular store. Table 400 is presented as a possible survey that can be completed by a consumer or buyer to indicate their preferences for selecting a store.

(A.2) Tangible Attributes

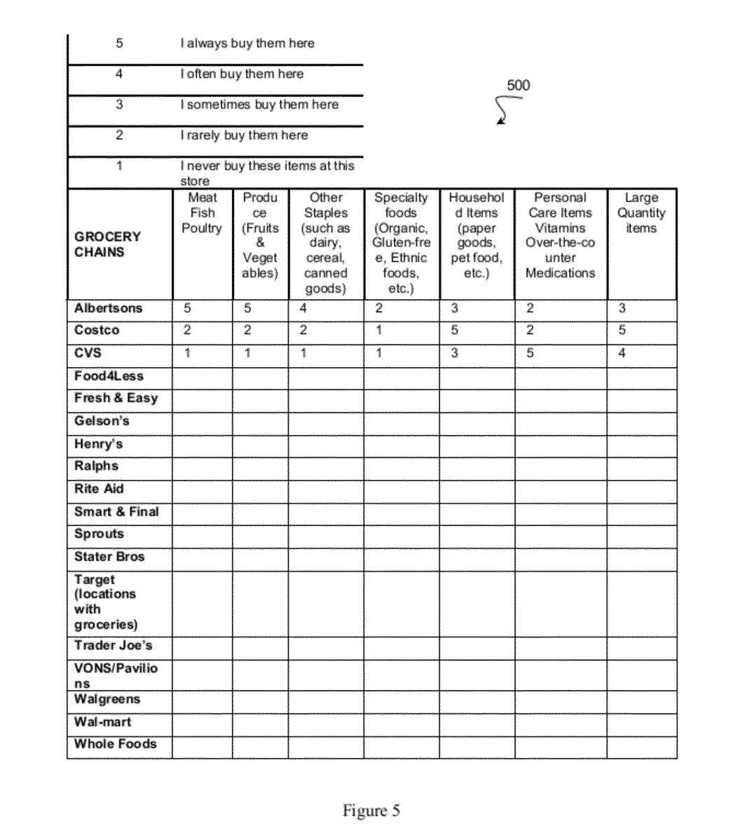

Refer to FIG. 5, table 500 represents some tangible motivation factors why a shopper shops for grocery items at a particular store. Table 500 lists various grocery stores that can be ranked or rated by a consumer or buyer to indicate their preferences.

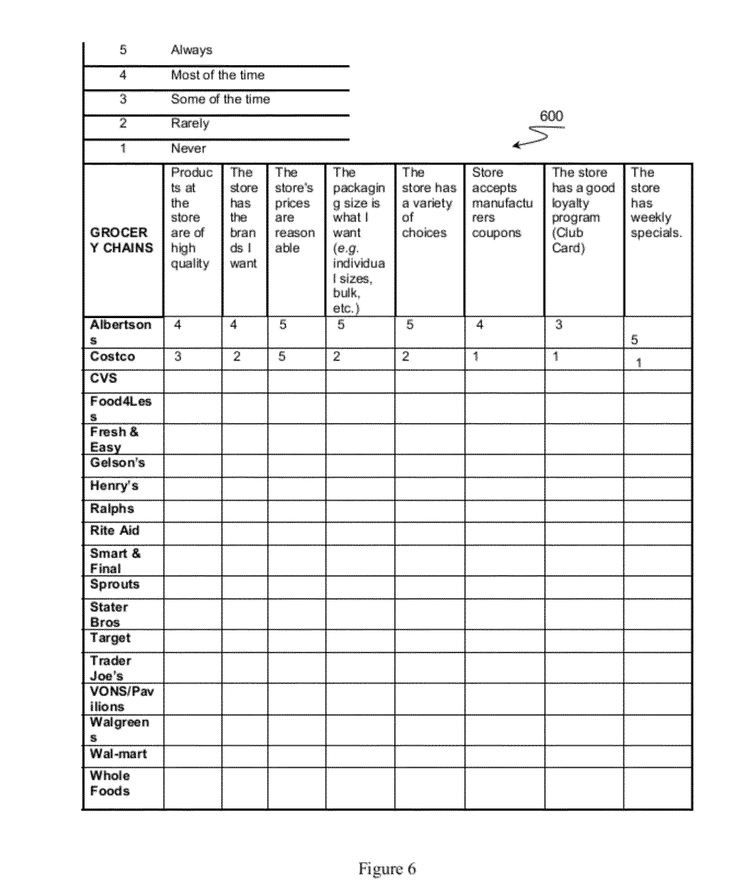

Refer to FIG. 6, table 600 represents additional tangible motivation factors why a shopper shops for grocery items at a particular store. Table 600 lists various grocery stores that can be ranked or rated by a consumer or buyer to indicate their preferences.

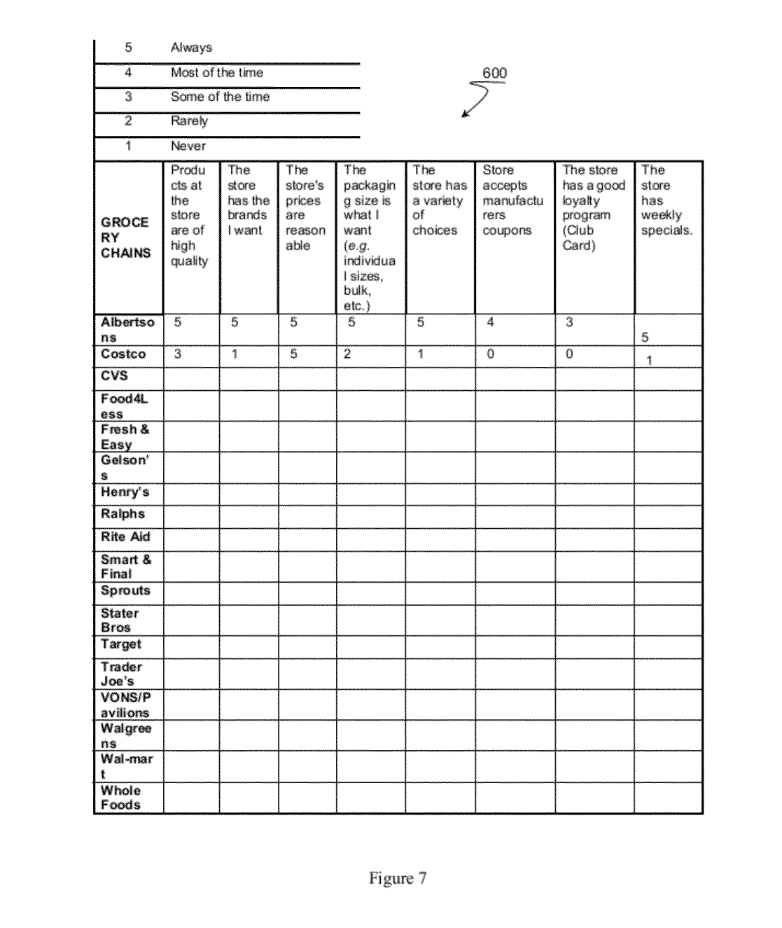

Refer to FIG. 7, table 700 represents some tangible motivation factors why a shopper shops for a specific perishable item (e.g. chicken) at a particular store. As with the previous tables, table 700 is presented as a survey form.

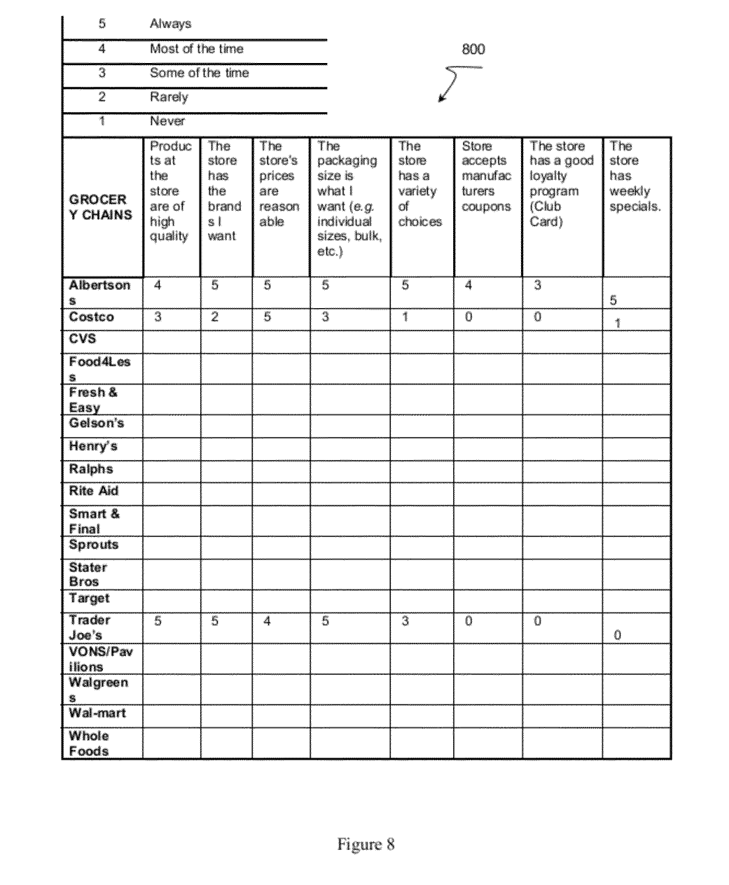

Refer to FIG. 8, table 800 represents some tangible motivation factors why a shopper shops for a specific non-perishable item (e.g. cereals) at a particular store. Table 800 is also presented in the form of a survey.

Although the tangible and intangible attributes are presented in tabular or survey form, one should note the attributes can also be obtained through automatic methods including using a discovery engine to derive correlations between shopping behaviors based on demographics and known attributes of existing products, goods, or services. Attributes can be bound to buyers, sellers, products, search result sets, concept objects, or other types of objects.

### (B) An Embodiment: a Platform for Economic and Instantaneous Discovery and Publishing Among Multiple Sellers and Multiple Buyers (Cyclic Shopping)

(B.1.) An Overview

In domains that present Intractability B (rapidly changing information) and Intractability C (unavailability of products or services or other acquisition impediments), an “ephemeral coupon” offered by the publisher when presented to potential consumers communicating purchase intentions (whether committed or non-committed) can help mitigate Obstacle B and Obstacle C.

To make this arrangement work, it is important to have a mechanism through which the publisher can gauge the number of patrons who will show up in order to manage their coupon offering financially. Better yet, shoppers should be aware of the coupon offer demand so that they can respond appropriately if the coupon demand becomes large enough to warrant concern about sufficient local supply of the product or service redeemable through the “ephemeral coupon”.

In a sense, this is a standard reservation system that has two additional features: (1) the publisher changes its prices according to demand and (2) the shoppers can submit “non-committed” or “committed” requests for the coupon. The system works in a feedback loop in the following manner: the publisher adjusts prices according to its capacity (or in-stock situation) and broadcasts price adjustments to shoppers; interested shoppers then signal their intentions (“reserve at this price”, “interested in, but not committed”); and then the publisher can respond with another round of adjustments and re-broadcast the offer.

### Example A

### When to Carry Out Cyclic Shopping?

Most shopping for products and services is of a cyclic nature—the shopper needs to buy similar, if not the same, products or services on a regular basis. Grocery shopping occurs more or less on a semi-weekly basis, a hair cut is monthly, an oil change is quarterly, and a dental visit maybe semi-yearly.

If the shopper buys roughly the same products or services each time in the particular cycle, he can be sent alerts just in time for when he's in need of a particular product or service.

### Example A-1

### An Example of Cyclic Shopping—Telling the Shopper where to go Grocery Shopping

With grocery shopping, a weekly must-do task for families, costs accumulate such that it is the third largest budget item for a family (after housing and transportation). Potential grocery shopping cost can easily be reduced by 15-20% with the right “optimization”.

A key feature of grocery shopping is the need for a basket (group or bundle) of products. Grocery shopping economy also features item comparables based on a variety of product parameters. The high flexibility in comparable products, the multiple choices of stores to shop at, and the options of when to shop for which items are all factors mentioned in Intractability A above.

One optimization existing in the current publisher-discovery paradigm and something every shopper knows about is that stores run specials weekly. If the shopper is flexible on what to buy, they can take better advantage of these published store promotions.

Another major optimization, which also stems from everyday observation, is that if you're willing to shop at an additional store, you can save even more by selecting among special offers from different stores. The difference in cost when making one extra stop is usually quite close to the mathematical minimum total cost achievable by stopping at every store for the lowest possible prices.

Still another optimization, which again stems from familiar experience, happens during the holidays when the one-time holiday grocery list is larger. Also, as many of the products on this list are probably purchased just for the holidays and not on a weekly basis, the shopper feels uncertain and becomes more open to guidance or discovery. By adjusting product pricing just for holiday shopping, stores stray from their routine pricing strategies and add further complexity for the grocery shopper when determining best price shopping. All of these factors create a larger potential for saving shoppers more money.

Grocery savings add up to a meaningful sum over time due to the necessity of purchasing multiple items at least once a week and also because most people need to make 50-100 shopping trips yearly. The aggregated savings in the roughly 10 billion grocery shopping trips each year is enormous.

As opposed to most other goods distribution, in the special case of grocery shopping, however, there is little information that's strongly ephemeral and the effect of Intractability C, product availability, is usually not in force. Typically, grocery stores are well stocked and it is unlikely that an unexpected surge of shoppers will clear out the grocery store stock of any particular item (except maybe at holiday times).

### Example A-2

### An Example of Cyclic Shopping—Telling the Shopper which Beauty Salon to go to

In the case of beauty salons, the above-mentioned Intractability A and Intractability B do not quite apply. Namely, a typical consumer has little flexibility in “comparables” in services: a haircut is a haircut, and cannot be substituted with a perm. Also, the pricing at beauty salons is typically static throughout months if not years.

However, (beauty salons start to offer “ephemeral coupons”—as in, “Come to our salon during the next two hours and get a $10 discount”—then the consumer might be able to benefit from the offer based on their own schedule's flexibility by taking advantage of the service provider's idle capacity.

### Example B

### An Example of Non-Cyclic Shopping—Informing the Shopper on Home Improvement Needs

What do you do when a consumer finds out that a wheel of their hand-truck is broken? Putting a new wheel on the hand-truck is easy enough, however, where to buy a replacement hand-truck wheel at all, let alone finding one of the correct size?

Through the function of labeling, Home Depot (or similar large home and garden stores such as Lowes, OSH) is considered as the hub that sells “everything” for the home. The consumer goes to Home Depot and most likely asks a clerk for help. Because the time expended on this one shopping trip is minimal, the consumer is unlikely to check the other of home and garden stores that are within driving distance for a better price or quality selection of hand-truck wheels.

Alternatively, a contractor who needs several hand-truck wheels at a time might purchase them at Home Depot without help from store clerks. Or, if well informed, is likely to have found a local hardware or home and garden store that sells the wheels for a cheaper price.

The evaluation of these two shoppers' behaviors illustrates the potential for the former shopper to save money just like the better informed contractor. By reducing the information barrier for the consumer through the use of tools providing ready access, the consumer's need is matched to the pertinent published hand-truck tire information.

Abundant other examples could be formulated around other purchasing activities enumerated by popular categories from the YellowPages.com (http://www.yellowpages.com/). These activities include but are not limited to: Attorneys, Auto Dealers, Beauty Salons, Dentists, Florists, Insurance, Mechanics, Plumbers, Restaurants, and Shopping.

(B.2.) A Description

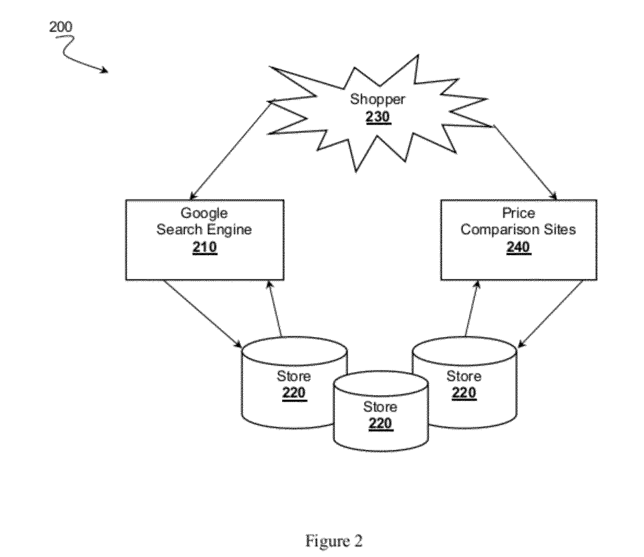

Without the platform, a shopper is trapped in a non-optimal environment 200 as depicted in FIG. 2. An independent search engine 210 seeks out information from stores 220 to create an index of available public information. When shopper 230 submits a product query to the search engine 210, search engine 210 returns a result set. Once shopper 230 is ready to begin comparison shopping, they must also consult one or more price comparison sites 240. Unfortunately, such an approach fails to optimize the shopping experience according to metrics or properties important or relevant to shopper 230.

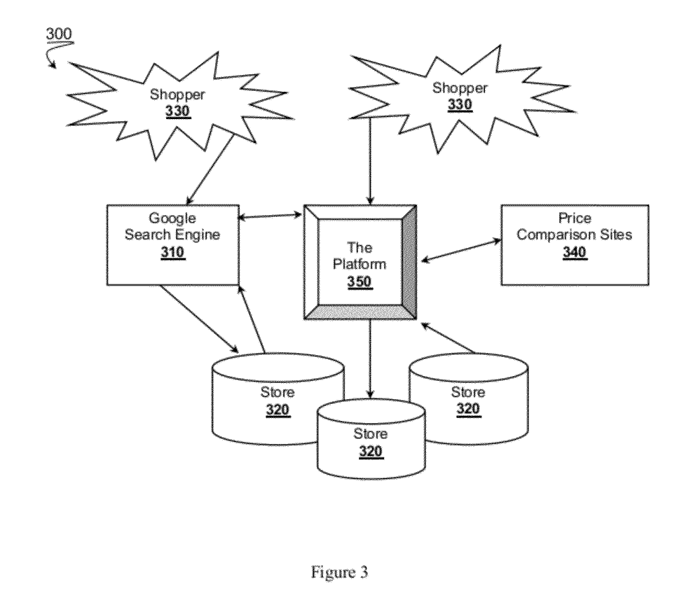

FIG. 3 presents a more optimal environment 300 having platform 350 configured to allow buyers or other shoppers to discover opportunities published by a seller. In optimal environment 300, shoppers can interact directly with platform 350 or indirectly through one or more other sites possibly including search engine 310 or comparison sites 340. Platform 350 can obtain product information from stores 320 including existing prices, store locations, product locations, promotions, features, or other information. Platform 350 aggregates the product information from multiple distinct stores and can analyze a query from shopper 330 to present an optimized shopping experience. Platform 350 can comprise a discovery engine that optimizes the shopping experience across multiple stores according to preferences of shopper 330 or other metrics: cost, time, travel route, locations, or other metrics.

(B.2.1) Discerning “Motivation Factors” of Shoppers

Refer to FIG. 5 Some Tangible Motivation Factors why a Shopper Shops for Grocery items at a particular store.

Refer to FIG. 6 More tangible motivation factors why a shopper shops for grocery items at a particular store.

Refer to FIG. 7 Some tangible motivation factors why a shopper shops for a specific perishable item (e.g. chicken) at a particular store.

Refer to FIG. 8 Some tangible motivation factors why a shopper shops for a specific non-perishable item (e.g. cereals) at a particular store.

When a shopper composes their shopping list, either from scratch, based on their previous lists, or based on someone else's list, their motivation factors can be discerned.

The discernment input of the input includes but is not limited to: they choose one product over another product in a context of alternatives, they chooses their store in a context of alternatives with a possible store change later, they choose a brand in a context of alternatives with a possible brand change later, they choose the product size and/or quantity and can change the possible size or quantity later.

The output of the discernment step, called “motivation factors” (namely the “right-hand meta profiles”), include but are not limited to: treating the store as a “one stop shopping” place, treating a store as a specialty items place, treating a brand as a primary choice factor and going to a different store to buy that branded product for a special event, or go to a store to shop for provisions for unexpected events.

The discernment step context employs algorithms that include but are not limited to: rule-based and statistics-based as well as prompting shoppers with questions and getting answers from the shopper.

The input to the discernment step includes but is not limited to: shopping lists, wish lists, and watch lists. Further, all subsets of a list (a list of 10 items has 1024 such subsets including the empty set) are considered by the discernment algorithm described above.

(B.2.2) Optimizing Motivation Factors that are Tangible

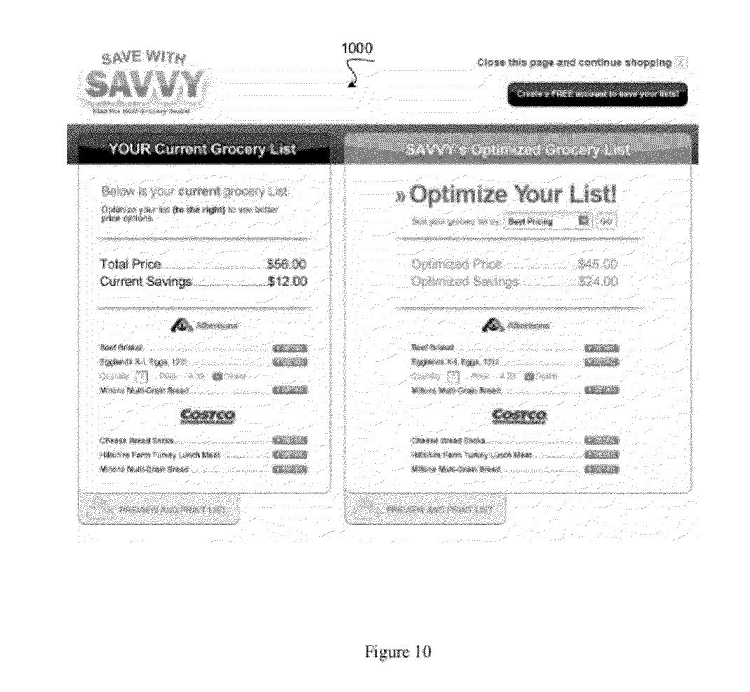

Refer to FIG. 10 where buyer interface 1000 provides for optimizing tangibles in a buyer's shopping list. Note the buyer has a current grocery list and a recommended optimized list across multiple stores based on one or more metric; pricing in this example.

Tangible factors to optimize include but are not limited to: price, packaging size and associated possible wastes, and the chance of finding items of interest once inside the store.

The methods of achieving optimization include but are not limited to: brute force optimization and randomized optimization.

(C) An Embodiment: a Platform that Issues “Ephemeral Incentives”

(C.1.) An Overview

Consider an end-to-end view of a shopper's researching, planning, store-visits and final purchasing. There has always been a need to “explain” why the shopper makes a certain purchase. That “explaining” is described by the shopper's activities prior to the final purchase, namely store-visits, planning, and researching.

Examples of such explaining are listed below:

“Which of three Reddi-wip® ads on the cherry pie website is converting to the highest percentage of purchases?”

“Are the initial splash page coupons getting more traction with consumers than when putting the coupon deeper into the site experience?”

“Which site visitation messaging (bundling, cost savings, superior quality, peer reviews) is leading to a higher percentage of purchase?”

The state of the art has been conducting “the explaining” with focus groups, hunches, etc. and have lacked empirical data except in tightly controlled and contrived experimental environments

(C.2) A Description

There is the need for a publisher of ephemeral information, and a consumer of such information, to be “connected” in a timely manner. The consumer is said to be “well connected” with publishers' information, when such information is relevant, deemed by the consumer, to their needs. The consumer can choose to “act” on the information; and such actions include but are not limited to: making a reservation, expressing an interest but not making a firm commitment, purchasing immediately, purchasing only after certain conditions are met over time, bidding, auctioning, etc.

The ephemeral information could be service capacity in a hair salon. It can also be the reduced price of a product at a store between 5:00 p.m. to 11:00 p.m. of the day.

A piece of ephemeral information can attach itself with its frequency of change (e.g., “a waiting queue being shortened by 1 person per hour”), or a characterization of such a frequency (e.g., “this could change by 10% within 2 minutes”, “this price will remain the same for 48 hours”).

A piece of ephemeral information can also attach itself with an expiration time that's expressed in absolute time in the future, or a relative time formulation for of calculating the expiration time.

Ephemeral information can also be the result of capturing the shopper's behavior throughout the research, planning, store-visit and final purchasing process for a particular shopping visit. A seller offer, or coupon, can be directly allocated to a particular shopper based on their research and planning during their act of discovery based on information presented by sellers. The coupon is stamped sufficiently with data (i.e., session id) to identify the individual shopper and the process that brought them to accept the offer. This ephemeral information may also be linked to related data about the buyer's research and planning from previous acts of discovery (list building).

When a shopper presents a coupon to purchase the item featured in the offer and stamped as described above at a particular store, the “explaining” process is complete for the seller whereas they know what was presented to the buyer (which Reddi-wip ad worked) as well as the store where the buyer frequents and how long a time transpired between receiving the offer and executing the purchase.

In the situation of one publisher with multiple consumers, it is of value to both the publisher and the consumers to know what actions all consumers have taken, or a characterization of such actions. To the publisher, consumers' actions can affect their courses of action. And to the consumers, other consumers' actions can affect their courses of action.

In the situation of multiple publishers with a single consumer, it is of value to both the publishers and the consumer to know what actions the publishers have taken, or a characterization of such actions.

In the situation of multiple publishers with multiple consumers, it is of value to both sides to know what actions have been taken, or a characterization of such actions.

A use case is as follows.

(Step 1) The user creates their shopping list,

(Step 2) A coupon code for a store's product that matches the user's behavior is displayed in the most effective context,

(Step 3) The user brings the coupon code with them to the store,

(Step 4) The coupon code is entered at the checkout of the store.

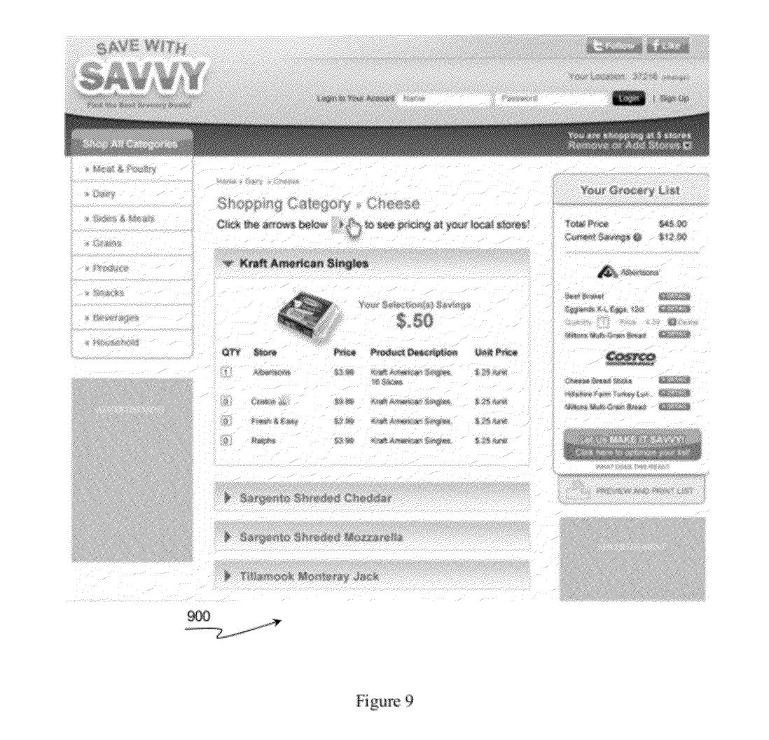

Refer to FIG. 9 where buyer interface 900 allows a buyer or other type of consumer to create a shopping list of chosen products across multiple stores.

The main mechanism for the matching is as follows:

a. develop a set of “left-hand-side meta profiles” representing product profiles associated with a publisher, based on tangibles and intangibles.

b. develop a set of “right-hand-side meta profiles” representing product profiled associated with a shopper, based on tangibles and intangibles.

c. create rules matching subsets of “left-hand-side meta profiles” with subsets of “right-hand-side meta profiles”.

Left-hand-side meta profiles include but are not limited to: perceived class of shoppers, price range, product selections within a particular category of products, product quality within a particular category of products, and friendliness of clerks.

Right-hand-side meta profiles include but are not limited to: brand consciousness on certain products, price sensitivity, size of family, overall spending habits, and whether status buying is important or not.

(D) An Embodiment: a Platform for Local Shopping and Services

A contemplated embodiment is a platform where local sellers of goods as well as providers of services can be matched with shoppers who plan a shopping trip and who might or might not be thinking about goods and services offered by the sellers or other providers.

The shopper connects with the platform and plans their grocery shopping on a regular basis. It is common that a shopper would plan her shopping for months before making a shopping decision, for example, in purchasing a home, an automobile, an electronic product, or other type of significant purchase. The shopper thus accesses the platform in multiple sessions over a long period of time (in months) with the purpose of eventually making one purchase at a physical store or an online store or over many locations. Thus, the shopper's available time-space in which a seller can interact with the shopper can be quite extensive or can comprise multiple shopper-related sessions (e.g., on-line sessions, real-life sessions, etc.). The platform stores the shopper's accesses or other session information made over time, and allows them to be retrieved later and used in new analyses. Since their “left-hand-side meta profile” is readily constructed, a local nail spa service provider that is connected with the platform (in that a “right-hand-side meta profile” of the service provider is available with the platform) can, through the platform, offer them something and some or all of their motivation factors (e.g., convenience of lumping driving together, lower price, higher quality, specific clerk that they feel most comfortable with) are optimized by the platform.

(D.1) An Embodiment: a Platform for Grocery Shopping of “Staple” Items and “Specialty” Items

### The Shopper's View

To work out an “optimal solution”: they (1) discover products; (2) know where to get them; (3) move unknown products to known products; (4) move “known products” to shopping routine; (5) optimize the shopping routine; and (6) discover more unknowns.

For example, for a specific shopper, they typically shop for 70% staple items—20% specialty foods—10% new growth points (switching to organic foods, for example). Therefore, a possible view of the shopper is as follows:

| | What to buy | Where to buy |
|---|---|---|
| Routine | Get “staple items”, and save | Already know where to buy. |
| | money and save time | Cherry picking helps. |
| | | Buying based on weekly |
| | | specials |
| Discovery | Get “specialty items”, and | Don't know where to buy, at |
| | get the right stuff | least not sure. |

The shopper typically develops a labeling (or “mindshare”) of various grocery chains. Common “labels” include but are not limited to: supermarkets (e.g., Ralphs®, VONS®, Food4Less®, . . . ), Big Box (e.g. Walmart®, Target®), Club Warehouse (e.g., Costco®, Sam's Club®), Dollar stores (e.g., 99 Cents®, Dollar General®), Small markets (e.g., Aldi's®), specialty (e.g., Trader Joe's®), Neighborhood markets (e.g., Fresh & Easy®).

### The Seller's View

In general, stock and adjust the “right mix” of products, so that they: (1) attract new customers; and (2) retain customers. In the presence of competing stores, the store's view could be: (1) compete for shoppers' attention; (2) adjust the mix of products being sold so that 70% of products “overlap” with other sellers stock and 30% is “our own” (store brand and non-competing products). A store might be the place a shopper shops for “staple” items and the store wants the shopper to be aware of the store's “specialty items”. On the other hand, a store that to most shoppers is a place for buying “specialty items” will want the shopper to consider the store's offers in “staple” items.

### The Manufacturer's View.

(D.2) An Embodiment: a Platform for Home Improvement Shopping

Consider shopping trips to home improvement stores such as Lowest, Home Depot®, OSH®, ACE Hardware®, and local hardware stores, local interior decoration materials stores.

A first distinguishing factor is that there are at least two kinds of shoppers. One kind of shoppers, typified by a contractor, know what kind of products (specs, models, sizes, materials) they want, and it is product's availability and pricing that are of major concern. The other kind of shoppers, typified by a consumer who has never worked around the house, does not know what kind of products to get, sometimes not even knowing how to properly describe a product to be purchased.

Another distinguishing factor is that repeated purchases are rare, at least for the consumer mentioned above.

Still another distinguishing factor is that many times the shopper would not know what to purchase, until seeing the displayed product(s) inside the store, a factor that is not unlike purchasing clothes.

A contemplated embodiment for home improvement is comprised of (1) a module that discerns the type of shopper; (2) a module that asks questions in order to solicit measures and descriptions of products; (3) a module that allow the browsing of similar products from different stores.

(E) An Embodiment: a Platform for Guided Discovery

One of the many goals of the disclosed subject matter is to reduce the mismatch between a publisher's perception of a shopper's intentions and the shopper's actual intentions. Often the publisher (e.g., a vendor, manufacturer, advertiser, distributor, retailer, etc.) publishes one or more promotions (e.g., offers, coupons, incentives, advertisements, etc.) targeting the shopper where the promotion's intentions fail to substantially overlap with the shopper's actual intentions. One possible result is the shopper fails to take interest in the promotion because it simply lacks relevance to the shopper's current intent. As discussed above, the mismatch can be reduced or eliminated by quantifying each entity's intention and attempting to guide the buyer toward the seller's promotion. Quantified intentions provide a platform through which shoppers can discover relevant opportunities or can be guided to relevant opportunities.

One aspect of the inventive subject matter is the appreciation that an entity's activities can be broken down into behaviors where each behavior is reflective of an intention. Behaviors can be considered a collection of one or more observable events, facts, queries, inputs, metrics or other collected or observed behaviors about the entity (e.g., shopper's last visit to a retail location, number of items purchased, etc.). The intention of an entity can be quantified through assigning one or more attributes to a behavior, where attributes fall within a namespace associated with an intention. Each intention (e.g., weekly shopping, shopping for birthday presents, shopping for breakfast, etc.) can have its own namespace or profile where intentions can have overlapping namespaces. Each intention can also be categorized as a “concept”.

Generating a discovery event, as discussed above, can take on many different forms. In some embodiments, a discovery engine operating as a rules engine can compare attributes of behaviors through various logical methods to determine if there might be a correlation between a behavior and an intention. For example, the discovery engine can attempt to seek a correlation between a behavior and an intention through deductive reasoning, abductive reasoning, inductive reasoning, or other types of correlating techniques. One should appreciate abductive and inductive reasoning can generate false positives, which is considered advantageous to the discovery process because they allow individuals to discover unknown unknowns where an individual can be presented with an opportunity that would not be presented within a purely deterministic deductive system. Such reasoning techniques can be applied to attributes of intentions or behaviors with respect to resulting actions taken by the various entities interacting with the system.

As the platform observes entity behaviors, a profile of the entity's intentions can be built. The platform can determine if the two entities can discover each other's intentions through applying one or more comparison algorithms (e.g., rules, criteria, multi-variate analysis, AI techniques, correlations, etc.) to overlapping intention namespaces. For example, a shopper purchasing milk and eggs might shop with the intention of baking. The publisher might have a promotion for bacon, which more closely relates to breakfast. However, overlapping namespaces between the intention of “baking” and “breakfast” can give rise to offering the shopper the bacon promotion because milk, eggs, and bacon also fit the “breakfast” concept.

Yet another aspect of the inventive subject matter includes offering a platform through which publishers are able to differentiate between shopper intentions. To continue the previous example, a publisher is able to make more than one offer having different intents to the shopper, possibly one for bacon (i.e., breakfast) and one for flour (i.e., baking). If the shopper utilizes one over the other, then the publisher gains a greater certainty of the intention of the shopper and can adjust other offers accordingly. For example, the publisher can generate coupons having greater enticements aligned with the target intent. Such an approach allows for validation of a hypothesis generated via the various reasoning techniques.

Even further, publishers can track changes in shopper behavior in response to receiving one or more intention-tailored offers. When offers are presented to shoppers, the publisher can track one or more behavior metrics, possibly in real-time, at least to within the hysteresis or lag time between generating the offer and observing behaviors. For example, a publisher might offer a steep discount on bacon and then the publisher can monitor point-of-sale data determine if there is a discernable change in sale metrics, or other metrics. Example metrics can include number of visits to a retail chain or store, number of purchases made, amount of money per unit time, or other metric. Such an approach provides for optimization of promotions or for tailoring a promotion to a target intention. Furthermore, such an approach also provides a feedback control through which the publisher can attempt to overcome shopper's static inertia.

As discussed above a shopper exhibits one or more behaviors which can be indicative of intent. A shopper following through with an intention can be considered to have inertia to continue with the intention, thus continuing forward with their shopping behavior. A publisher could monitor metrics after offering promotions with varying enticement levels to determine how best to overcome the shopper's inertia so the shopper might capitalize on an opportunity. For example, while in grocery store, a shopper might be quite willing to accept an offer for a product in the store when the offer has minimal enticement. However, a shopper might not be willing to accept an offer which requires the shopper to travel far from their planned route, unless the enticement is commensurately enticing.

The disclosed platform(s) allow publishers to determine thresholds for enticements at the behavior level, intention level, demographic level, or even at the shopper level through the use of observed response metrics. Thus, the disclosed platform can operate as a nearly continuous feedback system where publishers can directly or indirectly influence shopping behavior or shopping flow.

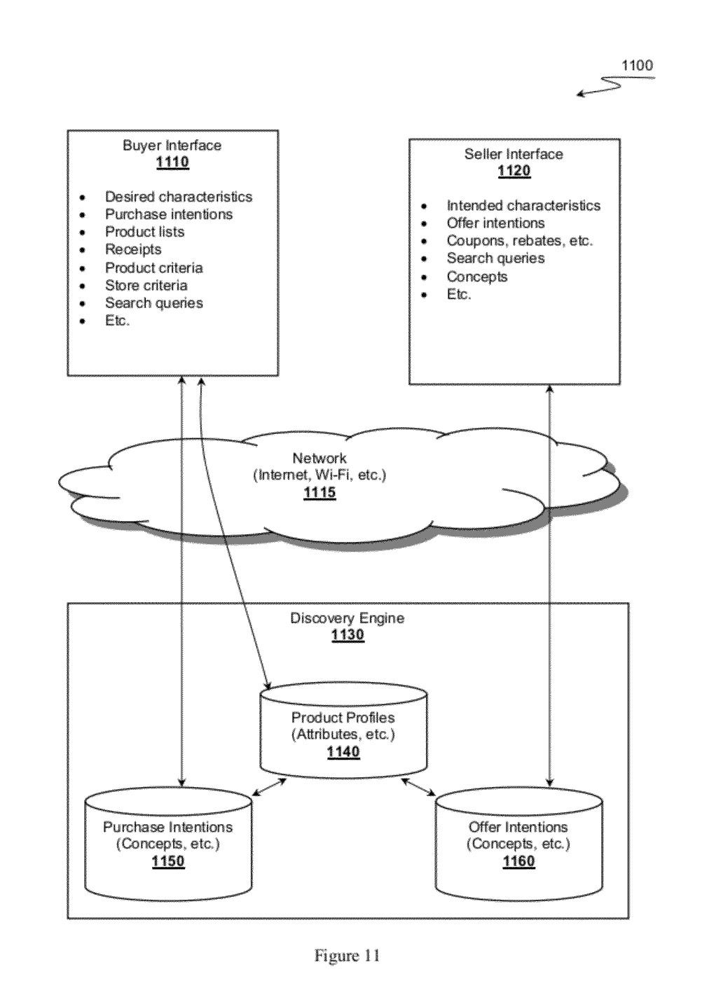

FIG. 11 presents a discovery environment 1100 where a buyer can discover opportunities published by a seller. Environment 1100 includes discovery engine 1130 operating as a rules engine capable of analyzing input from buyers or sellers while attempting to establish possible correlations among their various intentions. In some embodiments, discovery engine 1130 comprises a public search engine (e.g., Google®, Yahoo!, Bing, etc.) that indexes publicly accessible data records. In other embodiments discovery engine 1130 can comprise a proprietary search engine or database. For example, the search engine offered by a grocery store or shopping site could also operate as discovery engine 1130. Discovery engine 1130 operates as a proxy for other systems or other systems could operate as a proxy for discovery engine 1130.

Discovery engine 1130 operates on one or more concept objects stored in a memory, preferably concept databases where a concept object can be considered a digital representation of an intention. Treating intentions has concepts has been discussed in the Applicant's previous efforts as described in U.S. patent application having Ser. No. 11/754,081 titled “Searching With Consideration Of User Convenience” filed on May 24, 2007, and U.S. patent application having Ser. No. 13/038,150 titled “Offering Promotions Based on Query Analysis”, filed Mar. 1, 2011. Environment 1100 comprises two concept databases including purchase intention database 1150 and offer intention database 1160, although there can be any number of concept databases. Purchase intentions correspond to intention concepts of a buyer while offer intentions correspond to intention concepts of a seller. The concept objects stored in the various databases can also comprise attributes that describe various features of a concept object.

Consider a concept object representative of “Birthday Shopping”. The concept object would likely have attributes that would be considered to represent the generic concept of “Birthday Shopping”. For example, the concept object would likely have a name comprising a human readable string “Birthday Shopping”, a cake attribute, a decoration attribute, or other attributes that would likely correspond to birthdays.

One should note that each concept object can be built on other concepts at various levels of granularity. Therefore, a concept object can also comprises pointers to other concepts where the main concept object would inherit the attributes of linked concepts, perhaps by instantiating a new concept object or even weighting the inheritance of the linked concept's attributes. One should also keep in mind that multiple concept objects can be representative of the same concept. For example, a seller of party supplies might wish to define a concept object for “Birthday Shopping” to mainly focus (i.e., increase the weighting) of decorations, while a seller of party services might wish to define their concept object of “Birthday Shopping” in terms of organized party planning. Each seller might have their own concept object for birthday shopping with the same name, but each object could be instantiated according to drastically different criteria.

Concept objects are preferably defined in terms of a normalized attribute namespace where each attribute can be defined a priori. By instantiating concept objects according to the normalized namespace, the discovery engine can easily compare one concept object to other objects in the system. Furthermore, each concept object can have a degree of overlap with other concept objects. In some instances two concept objects would likely have little or no overlap; mayonnaise versus shoelaces for example. In other instances two concept objects might by very closely aligned; birthday shopping versus birthday parties for example. The degree of overlap can be measured based on number the attributes of each concept object, the relative weightings of each concept object's attributes, or both.

Discovery engine 1130 can also have access to one or more product profile database storing product information. In more preferred embodiments the product profile database stores product objects having attributes conforming to the same namespace as the concept objects. Such an approach is considered advantageous when comparing search results from a buyer's query to known or constructed concept objects. It is also contemplated that each concept representing an intention could have its own namespace.

Although more preferred embodiments focus on shopping, one should appreciate the inventive subject matter can be applied to other types of databases beyond product profile database 1140. Product profile database 1140 simply represents one type of database to which discovery engine 1130 has access. Other types of databases can include search engine databases, proprietary databases, medical databases, or other types of databases.

Each user within environment 1100 can access discovery engine 1130 over network 1115 through their respective interfaces. For example, a buyer or other consumer can utilize buyer interface 1110 operating as a browser to interface with discovery engine 1130 where discovery engine 1130 also operates as an HTTP server (not shown). The buyer can use buyer interface 1110 to submit or retrieve information from discovery engine 1130. For example, the buyer can compose a shopping list of grocery items or other types of products. The list can then be submitted in aggregate as a query to discovery engine 1130 for analysis. Buyer interface 1110 can be configured to accept various forms of input including desired buyer related characteristics, preferences, purchase intentions, product lists, receipts (e.g., scans, photos, etc.), shopping criteria (e.g., preferred brands, sizes, stores, locations, etc.), or generic search queries. Naturally a buyer's interaction via buyer interface 1110 would likely be significantly different the seller's interaction.

Sellers interact with discovery engine 1130 via seller interface 1120, which can also operate as a browser. In more preferred embodiments a seller pays a fee (e.g., subscription, per use, a percentage, etc.) to gain access to the services offered via discovery engine 1130. A seller can utilize seller interface 1120 to submit one or more attribute to be associated with the seller's intention for publishing a promotion. For example, a seller might wish to define a concept around a specific promotion relating to birthday shopping. The seller could submit attributes, possibly from a list of available attributes presented by discovery engine 1130, conforming to a namespace, relating the birthday shopping; wrapping paper, gifts, or cakes for example.

Seller related attributes can be bound to the seller's intention concept through various methods. In some embodiments, the seller can simply submit one or more attribute as desired. In other scenarios the seller could submit a query, perhaps a structured query or a natural language description of their promotion, where discovery engine 1130 derives attributes from the query or the query's result set. In yet other cases, discovery engine 1130 could analyze a seller's web site and offer recommendations on attributes or concepts. Regardless of how a seller provides access to attributes, the seller related attributes can be bound with one or more concept objects that represent the seller's intentions related their promotions.

One should appreciate discovery engine 1130 has access to a great deal of information relating to the intentions of the buyer or seller as well as attributes of products. Consequently, discovery engine 1130 can determine how closely a buyer's intentions are to a seller's intentions. As stated previously, one of the many disclosed inventive concepts is to allow a buyer to discover a seller's published promotion. Unfortunately, in many scenarios a buyer's intention simply lacks overlap with a seller's intention.

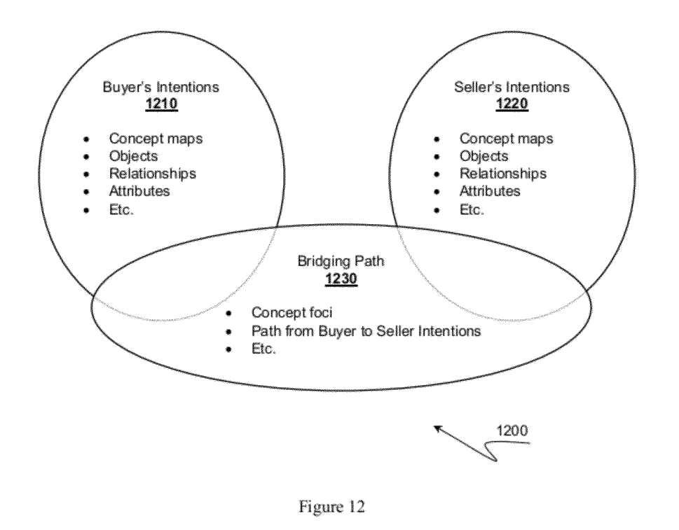

In FIG. 12, buyer's intention 1210 substantially lacks overlap with a seller's intent for a promotion. Buyer's intention 1210 can be derived through analysis of interactions or behaviors from the buyer including submitted search queries, preferences, returned result sets, entered attributes, defined relationships among objects, collected data, or other information. The discovery engine observes the buyer's behaviors as the buyer interacts with the system. Through the observations, the discovery engine attempts to map the behaviors to known or constructed concepts object. In a somewhat similar vein, the discovery engine also monitors seller's intention 1220. One should note that a concept object associated with seller's intention 1220 is likely more static relative to the concept object associated with buyer's intention 1210. Still, both could change with time. In the example shown, there exists little chance that a buyer would discover a seller's promotion.

In more preferred embodiments, the discovery engine can established an intention migration path represented by bridging path 1230 from buyer's intention 1210 to seller's intention 1210. Bridging path 1230 can comprise concept objects having overlapping attributes or namespaces where each concept object in the chain starting with buyer's intention 1210 is more closely related to seller's intention 1220. When a buyer interacts with the discovery engine, the discovery engine can modify returned information back to the buyer in an attempt to subtly influence the buyer's next interactions where the modified information more closely aligns with a next concept in bridging path 1230. Interactions between the buyer and the discovery engine can occur within on a search-by-search basis, across a search session, or over even across multiple search sessions.

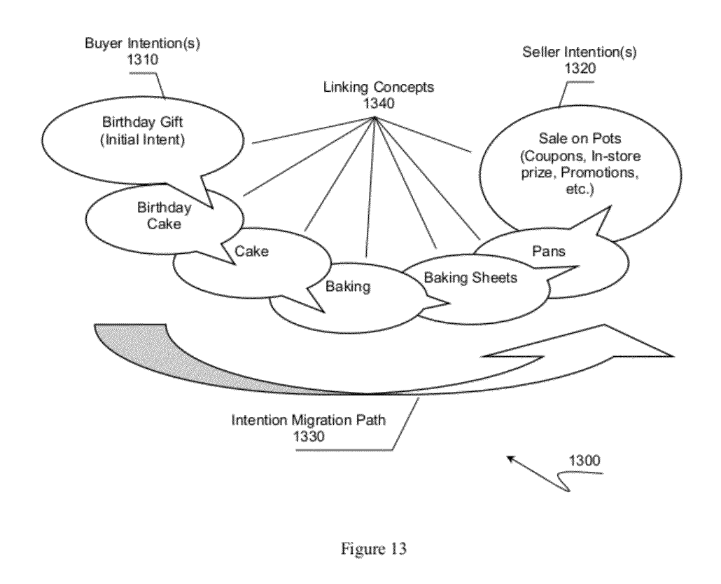

FIG. 13 presents a more detailed example 1300 for illustrative purposes. A buyer begins interacting with the discovery engine by submitting queries to a search engine. The discovery engine analyzes the queries or returned result sets to discover that the buyer appears to be shopping for a birthday gift as indicated by buyer's intention 1310. A seller has defined their seller's intention 1320 as wishing to sell pots and has an associated promotion (e.g., coupons, prizes, incentives, etc.). Ordinarily, the buyer would likely fail to discover the published promotion because buyer's intention 1310 lacks substantial overlap with the seller's intention 1320.

The discovery engine establishes intention migration path 1330 comprising a chain of linking concepts drawn from a concept database where the chain connects buyer's intention 1310 to seller's intention 1320. Each linking concept has overlapping attributes in a namespace with its neighbors where each concept progressing toward the seller's intention 1320 is more closely align or related with seller's intention 1320.

To continue the previous example, the buyer continues exhibiting behavior associated with the concept “Birthday Gift”. In response, the discovery engine identifies the concept “Birthday Cake” as a possible next step and modifies returned information to influence the buyer to migrate from their current intention to a “Birthday Cake” intention. One should keep mind that each intention is considered to be represented by a concept object, thus each intention can be considered a discreet, quantified object. The returned information can be modified by arranging or ranking items in result set that more closely align with the “Birthday Cake” intention in more prominent locations observable by the buyer. As the buyer continues to interact with the discovery engine, the discovery engine continues to observe the buyer's behaviors and when the behaviors indicate an alignment with “Birthday Cake”, the discovery engine can begin modifying result sets to conform to the next intention; “Cake” in general. Thus, the discovery engine indirectly influences a buyer's interactions until the buyer migrates through the chain: “Birthday Cake”, “Cake”, “Baking”, “Baking Sheets”, “Pans”, to “Pots”. As stated previously, the process can occur over a signal search session or over multiple search sessions associated with the shopper's time-space. One should appreciate that the time-space can be dependent on a time when a session takes place (e.g., absolute time, relative time between observed behaviors, etc.) or where (e.g., address, GPS location, altitude, position, city, zip code, etc.) the session takes place. When there appears to a sufficient alignment between the buyer's current intention and the seller's intention 1320, the seller's promotion can be presented to the buyer. Such an approach is considered advantageous because the buyer would likely be more accepting of a promotion matching their intent.

In the example, intention migration path 1330 comprises a single path. In some embodiments, the discovery engine establishes more than one path 1330. When multiple paths 1330 are available, the discovery engine can seek which path a buyer might be more apt to take. Thus the discovery engine can modify returned result sets to influence the buyer's interactions according to a signal path, or multiple paths. The discovery engine can further experiment to determine which of the multiple paths would likely have more success by measuring the buyer's behaviors. In some embodiments, the discovery engine could simply submit a question to the buyer requesting their intention where the user selects an item representing a current concept, a neighboring linking concept, or other concept in the chain. Therefore the discovery engine can actively guide the buyer or passively observe and influence the buyer.

An astute reader will appreciate that each step along path 1330 can begin the process anew. The discovery engine can continuously modify path 1330 according to the buyer's observed intention 1310 or even changes in the seller's intention 1320. For example, if the buyer is observed to deviate from path 1330, then the discovery engine has multiple options. One option includes establishing a new path 1330 while another option includes selecting a different seller's intention 1320 as a final target. From a seller's perspective, a seller might alter the attributes of their intention, which could affect path 1330 or the assertiveness of the discovery engine in attempting to influence the buyer. Perhaps the seller sets an attribute associated with seller's intention 1320 setting a time limit for a corresponding promotion. The discovery engine can attempt to influence the buyer within the time frame.

The example presented in FIG. 13 illustrates a one-to-one relationship between a buyer and a seller. One should note that many buyers and many sellers can participate in the system. Therefore migration path 1330 can comprise linking concepts 1340 corresponding to intentions of many different sellers where the discovery engine derives path 1330 based on a subset of seller's individual intentions or possibly based on fees paid by the sellers. Additionally, many buyers can migrate along a single path, multiple paths, or individualized paths toward seller's intention 1320. The buyers can then discover seller's published promotions as they interact with the discovery engine. Furthermore, the buyers can operate en masse possibly based on demographics where the discovery engine establishes path 1330 based on the demographics of the buyers.

In some embodiments, sellers can view one or more paths and observe how populations of buyers migrate from one linking concept to another. Through such observations, sellers can make better decisions on how to position their published promotions relative to competitors or relative to the population according to demographic attributes (e.g., age, gender, location, income, etc.). In view that multiple sellers can compete over population migration, management of paths 1330, or linking concepts 1340, each of these capabilities or objects become valuable commodities that can be monetized.

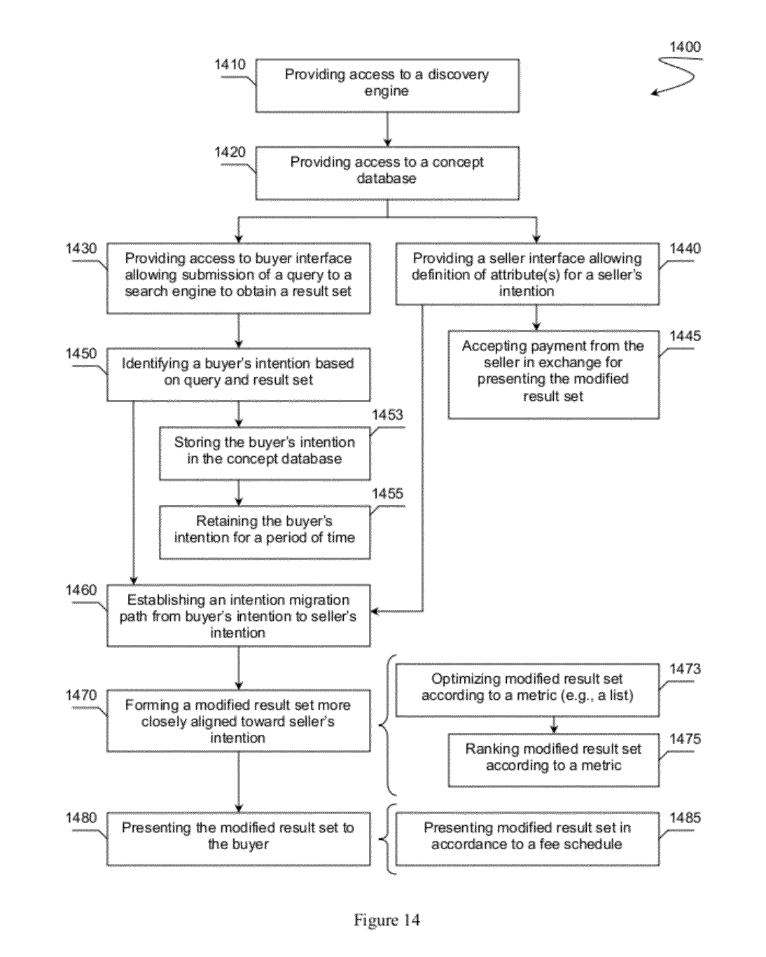

FIG. 14 illustrates possible method 1400 of publishing by a seller and discovering by a buyer via a discovery engine. Method 1400 provides additional details regarding the discovery process based on the above disclosed techniques.

Step 1410 comprises providing access to a discovery engine configured to map a seller's intentions with one or more buyer's intentions. A discovery engine can comprise a suitably adapted search engine. In other embodiments, the discovery engine can comprise a propriety computing device or rules engine capable of coupling within remote users over a network. Access can be provided or otherwise made available over network after applicable authentication or authorization.

Step 1410 includes providing access to one or more concept databases storing concept objects. Each concept object can be considered a digital representation of an intention characterized by attributes. Preferably the attributes conform to a normalized namespace allowing comparison of concepts to each other. In some embodiments, each concept can have its own namespace.

From a seller's perspective, step 1440 can include providing access to a seller interface through which a seller can define one or more attributes associated with a seller's intention as represented by a concept object. The discovery engine can aid the seller through the definition process by offering the seller available attributes from one or more normalized namespaces, through deriving an intention concept from seller interactions or seller provided information, or through other interactions. In more preferred embodiments, the seller interface comprises a web browser through which the seller can gain access to the discovery engine. As contemplated by step 1445, the disclosed system can further accept payment from the seller via the seller interface in exchange for presenting promotions as part of a modified result set as discussed further below.

From buyer's perspective, step 1430 includes providing access to buyer interface, through which a buyer can submit a query to a search engine capable of generating a result set considered responsive to the query. As with the seller interface, a preferred buyer interface can also comprise a web browser. In some embodiments, the discovery engine and the search engine comprise the same computer device(s), while in other embodiments the discovery engine can operate as a proxy for the search engine or behind the search engine.

The buyer's query can take on many different forms. The query can include a simple keyword query, natural language query, a shopping list (e.g., a grocery list, etc.), a digital representation of a receipt (e.g., scan, image, photograph, digital file, etc.), a buyer's preference or other type of query capable of electronic submission. The modality of the query can also cover a broad spectrum of data types including audio data, visual data, text data, or other type of data capable of being submitted by the buyer. One should appreciate that the query is considered to be indicative of a buyer's behaviors as they buyer interacts with the disclosed discovery engine.

Step 1450 comprises the discovery engine identifying a buyer's intention as represented by a concept object based on the query submitted by the buyer and based on the result sets returned by the search engine. The buyer's intention concept can be identified through the discovery engine comparing attributes derived from the query (e.g., product types, location, preference, lists, etc.) or from the result set to the attributes of concepts within the concept database. If the derived attributes satisfy selection criteria of one or more concept objects, then the identified concept objects can be considered to correspond to the buyer's intention concept. The identified concept objects can be ranked by a likelihood of corresponding to the buyer's actual intent. The likelihood can be calculated based on the number of matching attributes (i.e., the extent of overlap) or weighting factors of matching attributes (i.e., the quality of the overlap).

In some embodiments, a buyer's intention concept can be constructed as a new concept that might not yet be within the concept database. If so, step 1453 can include the discovery engine storing the constructed buyer's intention concept as a new concept within the concept database. New concepts might require later analysis to be properly categorized or named, but such a step is not necessarily required. Once stored, the buyer's concept history of intention concepts can be retained for as long as desired or for a specified period of time as indicated by step 1455. For example, buyer's intention concepts could be retained for at least a year, a month, a week, a day, an hour, a minute, a second, or other time period. Such an approach is considered advantageous to allow the discovery engine to determine possible correlations among concept objects and buyer demographics by analyze intention history across many buyers.

Step 1460 includes the discovery engine establishing an intention migration path from the buyer's intention to the seller's intention where the path comprises a chain of linking concepts. The linking concepts are obtained from the concept database and metaphorically arranged so that each linking concept object has attributes that overlap its neighbors (e.g., number, weighting, etc.). Each linking concept progressing toward the seller's intention preferably corresponds to a closer concept to that of the seller's intention. One should appreciate that it is quite likely that the seller's intention concept and the buyer's intention concept lack overlapping concept attributes or overlapping namespace during the process. For example, when the query is submitted as a first query of the search session, the buyer's intention concept might likely have nothing to do with the seller's intention concept.

Step 1470 further includes the discovery engine forming a modified result set from the result set responsive to the buyer's query. The modified result set can comprise items having attributes that more closely align to a next linking concept in the intention migration path relative to the buyer's intention concept. For example, when a buyer submits a query as a grocery list, the modified result set can include products that might deviate from the query and converge more closely toward the next linking concept.

The modified result set can take many different forms. In more preferred embodiments, the modified result set can include a promotion from the seller, possibly under the conditions when the buyer's intention concept aligns with the seller's intention concepts. Alignment can be determined by comparing derived attributes from the query, result set, or other buyer behavior data to the attributes of the seller's intention concept. If the derived attributes satisfy alignment criteria, then alignment can be considered as achieved. The criteria can be based on the number of matching attributes, the value of the matching attributes, a calculated value derived from attribute weightings, a threshold value, or other factors. The promotion can be presented in response to a single search query, presented across multiple queries in a search session, or across multiple search session.

The modified result set can also comprises a shopping list, possibly in response to query representing a grocery list. The shopping list can include recommended items or brands that more closely align with the next linking concept. In more preferred embodiments the shopping list comprises a grocery list derived from the buyer's query or the result set. For example, a buyer submits a weekly grocery lists with minor modifications targeting a party. The discovery engine generates a new grocery list having products aligning with the seller's promotion or a next linking concept, possibly targeting a birthday party.

Step 1473 contemplates that the discovery engine optimizes the shopping list based on one or more metrics. The discovery engine can determine which metrics would be most beneficial based on many different factors. The metrics could be selected based on buyer preferences, buyer demographics, current buyer's intention concepts, target seller's intention concept, current target linking concepts, or other factors. Example metrics could induce cost of items on the list, cost of aggregated items, store locations, a shopping travel route, a shopping time, store preferences, or other metrics. Furthermore, the discovery engine can rank or present optimized shopping lists according to the metrics as indicated by step 1475.

Step 1480 comprises the discovery engine causing the modified result set to be presented to the buyer via the buyer interface. The modified result set can be presented directly from the discovery engine or through a proxy, a search engine for example. Regardless of how modified result set is returned to the buyer, the buyer interface can be configured to present the modified result as desired.

Preferably the modified result set, possibly including a promotion from the seller, is presented according to a fee schedule as indicated by step 1485. The schedule can specify various conditions of how the modified result set should be presented. Example conditions include a time, a location on a display, a geographic location, a ranked position in the set, allocation, or other consideration. For example, if the buyer interface comprises a cell phone, the promotion might only be displayed when the buyer is at a specific location based on the cell phone's GPS coordinates.

One should appreciate the disclosed method can be used to subtlety influence a buyer's behaviors to guide the buyer toward a seller's intent. However, the buyer might not exhibit behaviors that appear to align with the intended intention migration path. Therefore, the inventive concepts are also considered to include iteratively conducting at least some of the above steps of method 1400. For example, through one or more buyer search sessions, the discovery engine can repeat the steps 1460, 1470, and 1480 in an attempt to influence buyer behavior.

Thus, specific embodiments and applications of auction methods and related improvements have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A method of publishing by a seller and discovering by a buyer, the method comprising:
providing access to a discovery engine configured to map a seller's intentions with a buyer's intentions;
providing access to a seller interface through which a seller can define at least one attribute of a seller's intention concept;
providing access to a buyer interface through which a buyer can submit a query to a search engine capable of generating a result set responsive to the query;
providing access to a concept database storing concept objects having attributes describing corresponding concepts;
identifying, by the discovery engine, a buyer's intention concept representative of a buyer's intention based on the query and attributes related to the result set;
establishing, by the discovery engine, an intention migration path from the buyer's intention to the seller's intention comprising a chain of linking concepts from the concept database, each linking concept having overlapping attributes to its neighbors;
forming, by the discovery engine, a modified results set from the result set to more closely align with a next linking concept relative to the buyer's intention concept; and
presenting, by the discovery engine, the modified result set to the buyer via the buyer interface.

2. The method of claim 1, wherein the modified result set comprises a promotion from the seller when the buyer's intention concept aligns with the seller's intention concept.

3. The method of claim 2, further comprising presenting the promotion across a buyer's search session according to a fee schedule.

4. The method of claim 1, further comprising iteratively conducting the steps of establishing the migration path, forming the modified result set, and presenting the modified result set during a single buyer search session.

4. The method of claim 1, further comprising accepting payment from the seller via the seller interface in exchange for presenting the modified result set directed toward the seller's intention concept.

5. The method of claim 1, wherein the seller's intention concept and the buyer's intention concept lack over lapping concept attributes.

6. The method of claim 5, wherein the seller's intention concept and the buyer's intention concept lack over lapping concept attributes when the query is submitted as a first query of a search session.

7. The method of claim 1, further comprising storing the buyer's intention concept within the concept database.

8. The method of claim 7, further comprising retaining the buyer's intention concept for at least a specified time period.

9. The method of claim 8, wherein the specified time period comprises one of the following: a year, a month, a week, a day, an hour, a minute, and a second.

10. The method of claim 1, wherein the modified result set comprises at least one shopping list.

11. The method of claim 10, wherein at least one shopping list comprises a grocery list derived from the query and result set.

12. The method of claim 10, wherein at least one shopping list comprises at least one optimized shopping list.

13. The method of claim 12, further comprising the discovery engine optimizing the shopping list according to at least one metric.

14. The method of claim 13, wherein the metric at least one comprises a cost.

15. The method of claim 13, wherein the metric at least one comprises a route.

16. The method of claim 13, wherein the metric at least one comprises a time.

17. The method of claim 13, further comprising ranking and presenting the at least one optimized shopping list according to the at least one metric.

18. The method of claim 1, wherein the query comprises a shopping list.

19. The method of claim 1, wherein the query comprises a digital representation of a receipt.

20. The method of claim 1, wherein the query comprises a buyer's preference.

21. The method of claim 1, wherein the query comprises at least two queries.

22. The method of claim 21, wherein the at least two queries differ in a time submitted by at least two days.

23. The method of claim 21, wherein the at least two queries differ in a location from which they were submitted.

24. The method of claim 21, wherein at least one of the two queries comprises a stored and retrieved query.

25. The method of claim 24, wherein the buyer's intention is identified based on the stored and retrieved query.
